(19) United States
(12) Patent Application Publication
(10) Pub. No.: US 2017/0247094 A1
(43) Pub. Date: Aug. 31, 2017

(54) SYSTEM, METHOD AND DEVICES FOR HANDLING BOATS STORED IN A DRY DOCK USING A ROLLING BRIDGE AND SLIDING TOWER

(71) Applicant: Gerard Giroud, Montpellier (FR)

(72) Inventor: Gerard Giroud, Montpellier (FR)

(21) Appl. No.: 15/512,578

(22) PCT Filed: Sep. 26, 2014
(86) PCT No.: PCT/IB2014/064879

§ 371 Date: Mar. 20, 2017

(51) Int. Cl. B63C 15/00; B63C 3/06; B66C 17/00

(52) U.S. Cl. CPC B63C 15/00; B66C 17/00; B63C 3/06

(57) ABSTRACT

Device for the handling and storage of boats in a vertical dry dock. The boats (16) are removed from the water (7) via forks (13) which slide in a sliding fork-shaped system (12) carrying a cradle (10). The forks are displaced via a motor driven rack and pinion (14) system. The run of the rack and pinion system is limited by sensors (5 et 20). The entire mechanism is supported by a structure (8) which carries a tower (9) and a sliding fork-shaped system (12) that enables the cradles (10) to be deposited in berths (2, 2a). A rolling bridge (6) enables the entire assembly to be moved along X, Y and Z axes. The device is specifically useful for vertical dry dock management of boats, allowing the latter to be removed from the water and stored safely, or removed from storage and placed onto the water, as needed.

The present invention relates to a device, system and methods for manipulating, storing and managing said stored objects, in particular for storing and handling boats in corresponding storage spaces in dry docks.

Increased protection of the coastline against urban development, an insufficient number of wet mooring berths capable of dealing with the expanding development of pleasure boating, and the desire to store and protect boats from corrosion and bad weather for periods of time when the boats are not in use, have led to the development of buildings for housing said boats on land. Such constructions are generally known as vertical dry docks.

In such vertical dry docks, boats are generally removed from the water and stored in boat parking spaces which are comprised of compartments arranged along sets of openings or corridors disposed in parallel between vertical supports in order to reduce the surface area used by the construction. Prior to parking, the boats are usually hosed down with domestic water, as opposed to seawater, as this is considered by many to be an essential service necessary to protect against corrosion, particularly before immobilisation of the boat for a long period, for example, over the winter.

Known systems and devices to date have been described in several patent applications and patents.

For example, European patent application EP1201536 to Jouve, describes an automated dry dock system and device. In this system, the boat is brought to the quayside and positioned in a hoist trolley much larger than the boat itself. The hoist trolley is attached to a hoist or elevator system that runs along a rail. The rail rises vertically, in order for the boat to be lifted from the quayside by the hoist system, and then another tangentially positioned rail system with a cross-over rail and corresponding counter-balance wheels on the hoist trolley is provided, in order to prevent the trolley from tipping over as it engages the change of direction. The horizontal rail then moves the trolley towards a circular storage carousel, at which point the load, i.e. the boat, is transferred via rails to a central turntable system that can be raised or lowered within the carousel. At the desired height, the boat is moved from the turntable to a housing berth or parking space, requiring yet another load transfer. The carousel houses the parking spaces for the boats which are disposed in radial fashion around the central turntable. This system thus involves at least two transfers of the load when moving a boat from the water to its berth and the use of a complex cradle to support the boat during movement. Additionally, the civil engineering work required to get the system up and running is significant, complex, and various other boat movements involved require extra handling operations and several loading and unloading manoeuvres, before a boat can be removed from the water and parked, or vice-versa, removed from its parking place and set to water.

Another known system is of the type described in French patent FR2901535 to Giroud. In this patent, a rolling bridge system is moved over the water. A vertically sliding forklift system, attached to a fixed length and vertically fixed rigid upper support frame, carries a pallet which is deposited in the areas where the boats are to be parked. The vertically fixed and rigid upper support frame is attached to a central crown, which can be rotated in order to turn the forks, pallet and boat about a central vertical axis. The forks, however, have no horizontal sliding movement capability, and the upper support frame is not movable in a vertical direction. One major disadvantage of such a system is that, in order to be able to rotate the boat taken from the water, it is necessary to provide a much greater space in the central corridor or opening, which thereby increases the surface area covered by the vertical dry dock building, and additionally, for any given surface area, reduces the number of boats that can be stored thereon.

U.S. Pat. No. 4,953,488 to Heidtmann discloses a carousel-type vertical dry dock system where the boat elevator device is provided outside of the storage building, the building itself being provided with motorised means for turning the building structure in order to position a housing or parking space opposite the correspondingly positioned boat which has been raised from water level by a crane system comprising pincers or grab arms to grasp the boat. The use of such arms is potentially very damaging to the boat's hull and preventing the boat load from swinging around whilst on the move, e.g. when turning from a facing out, waterward position, to a facing inward, boathouse position, also poses a significant number of technical challenges, increasing the complexity and cost of setting up, and operating such a system.

U.S. Pat. No. 6,007,288, and U.S. Pat. 7,367,747, as well as US patent applications US20050035259, US20090304480, US20120114417, all to Maffett et al, disclose a vertical dry storage system for boats involving a boat cradle that is attached directly to a cable winch system. The cradle itself must be docked with support rails provided in the berths of the housing structure, whereby the support rails engage in corresponding grooves provided within the cradle. This requires a great deal of control and precision over the movements of the cable hoists, and with swing movements involved in shifting loads at the end of support cables, even if contained within a cradle larger than the size of the boat, one can expect boats to move sufficiently out of alignment during translational movement, that an increased risk of collision with the structure is likely. Additionally, the space requirements of such a system are directly proportional to the way in which the boats are stored, i.e. longitudinally, or along the boat's longitudinal axis from the central corridor. This means that the depth of the support structures for the berths must be at least as long as the longest of the boats to be stored, and the building must provide for sufficient space to be able to rotate the boats in their cradle in order to insert them into their berths, thereby increasing the overall width, surface area, and cost, of the building, and moreover, reducing the total number of boats that can be stored per given predetermined surface area, as each boat has an individual berth.

All of the devices and systems described above, however, have a number of important disadvantages:
the systems used to grab the boats are expensive and complex;
the risk of damaging the boat is always present, due to the increased handling and movement of the latter;
as the various handling operations are themselves complex, the known systems do not easily lend themselves to complete automation.

The devices, systems and methods according to the present invention overcome said limitations and disadvantages, and in particular:
enable the management of the complete set of handling operations: removal of the boat from the water, translation, lifting and storage of the latter via a single system made from components readily available in general commerce;
avoid costly and expensive civil engineering or maritime works, with no, or only an optional, requirement to build quays or maritime docks;
enable complete automatic management of the various handling operations, thereby allowing the desired parking spot to be reached via an XYZ coordinate system inside the vertical dry dock system;
enable moving a boat into its parking space or removing it from said space, via, for example, a coded card, that commands and controls a completely automatic and user-friendly and safe system.

The vertical dry dock system according to the invention is made up of one or more parallel openings formed between vertical supports, each one comprising a central passage or corridor, which is free of obstruction, to allow for the movement of boats in and out, the boat handling device, and parking spaces located on either side of the passage or corridor, on one or more levels. The device according to the invention consists of a mechanical displacement system to move watercraft from when they arrive, floating at the water's edge, to their parking spot on the ground, in their allotted berth, all without interruption of load on the system during transfer, and fully automatically. According to one embodiment, the device includes:
a roll path formed by at least two parallel rails which project out over the water in one direction, and extend into a passage or corridor of the building in the opposite direction along the whole length of said passage or corridor. The roll path is located at a height which is sufficient to vertically cover all of the storage spaces along the path, and preferably bears down on the external vertical uprights of the opening. A rolling bridge moves along the roll path, the bridge being formed by two parallel beams that are perpendicular to said roll path. This direction of movement of the rolling bridge along the roll path is called the X axis. A movable chariot moves along the whole length of, and on, at least two beams that form the framework of the rolling bridge, thereby covering the whole width of the openings. This direction of movement of the movable chariot is called the Y axis.

Within the XY axes of the moving rolling bridge, a mobile chariot system is located that has a vertically movable structure, the height of which can be adjusted, preferably defined as a sliding telescopic tower. The chariot is thus movable on the rolling bridge along the Y axis, whereas the Z axis corresponds to vertical movement of the vertically movable structure, in the present case, the sliding telescopic tower. The sliding telescopic tower is equipped with a prehensile assembly at its lower extremity, in the present embodiment a horizontally sliding forklift system, that enables boat support cradles to be lifted and lowered along the Z axis, and then moved or translated along the X and Y axes. The vertical Z axis movement can be achieved, for example, by pulleys and winches, or via hydraulic pistons, or any other suitable hydraulic or mechanical system. The forks engage a boating support cradle via horizontal sliding displacement of the forks on either side of the vertical axis of the telescopic tower, and as required when either withdrawing a boat from its berth, or when depositing a boat into its storage berth.

The horizontally sliding forks are moved forwards and backwards on both sides via rack and pinion means or another similar system, the movement of which is controlled by positioning sensors located on the sliding forklift system attached to the telescopic tower, and respectively, at corresponding locations on the boating support cradle. The sliding forklift system is also movable vertically along a relatively short distance of the telescopic tower, in order to allow for fine, or precise, vertical positioning control when taking a boat support cradle from a berth, or when putting said support cradle back onto a berth.

On either side of the telescopic tower, the sliding forklift systems are equipped with rack and pinion means, in order to balance out the loads, and enable boats to be taken from, and deposited into, berths on either side of the opening and central passage, without having to rotate them about the tower. One major advantage of such a non-rotating system is a notable saving in surface area required for manipulating the boats when transferring to or from their berths. The extra space gained through the use of this system can also be used, for a predetermined fixed surface area, to store a greater number of boats per square meter, or boats of greater width, for example, by increasing corresponding storage strut support length and berth depth.

The system and device according to the present invention thus allows for the boat support cradles borne by the fork-shaped systems to be freely moved from one area of the opening, or central corridor, to any other part thereof, thereby optimising use of the available storage space. Generally, the cradles are adapted both to be engaged by the sliding forklift systems so that they can be handled correctly, and also to the geometry of the boats to be handled. The handling device carried by the rolling bridge can then move on to subsequent boats to be handled.

The cradles are laid on storage berths which are arranged parallel to the length of the opening, corridor, or central passage. The vertical run of movement in the telescopic tower and horizontally sliding forklift system is sufficient to enable it to be lowered to ground level and even below the water level, depending on the loads to be handled. The device functions generally as follows :
a boat support cradle is engaged by the sliding forklift system at a berthing space, and removed therefrom by reverse horizontal movement of the forks via the rack and pinion means until it is clear of the berthing structure and free to move up and down the length of the central corridor, and up and down vertically;
the rolling bridge is then moved along the upper rails and corresponding roll path, which in turn displaces the chariot holding the telescopic tower and sliding forklift system, to a point just above the water, whereafter the sliding forklift system and boat support cradle are lowered into the water to a level located beneath the lowest depth of a boat to be handled—for the majority of boats envisaged by the system, device and method of the present invention, this depth corresponds to approximately 1.5 meters below the lowest part of the boat to be handled;
the boat moves to a position above the sliding forks, bearing the cradle, and then the forks are moved into position such that the cradle now supports the hull of the boat, thereby preventing the forks from coming into direct contact with said boat;
the forks are then raised, via retraction of the telescopic tower, to the desired height corresponding to the height of the berth in which the boat is to be stored;
the rolling bridge is then moved along the roll path once more to a spot in alignment with the storage berth to be used for the boat;
optionally, any fine adjustment needed in positioning the height of the boat support cradle with respect to the berth can be carried out via the vertical displacement means of the sliding fork system, either before movement along lo the rolling bridge roll path, or alternatively, once the cradle has already effected this movement—generally, the boat support cradle is positioned to be slightly above the final resting position of the cradle in the berthing space, to allow for clearance when moving the forks forward into the berthing space;
the cradle is then deposited into the storage berth via horizontal extension of the sliding forks, the sliding forklift system lowered to allow for withdrawal thereof from the cradle, thereby enabling the cradle to rest on the berth, and subsequent withdrawal of the forks in the opposite direction back towards the telescopic tower.

A known device can optionally enable the rolling bridge on one roll path to be moved from one opening having a central passage to an adjacent opening with its own passage and having a separate roll path located above it. This movement occurs along the Y axis. An example of such a device is a transfer bridge and comprises a rolling bridge that is moved on rails which are perpendicular to the axes of the openings and which carries a part of the rails of the rolling path on which the rolling bridge carries the telescopic tower, sliding fork-shaped system and boats, along the X axis. Such a system makes it possible to move the rolling bridge from one opening to another along the Y axis.

Some of the advantages of the present invention are given below:
boats are located on their cradles in their corresponding berths, for example, three or more different sizes of cradle can be used depending on the size of the boat to be handled ;
the cradles all have a lower base structure which is common to each type of cradle, and an upper structure adapted to the size and particular conformation of the boat to be handled. Such a cradle enables manipulation of the boat without touching it, and additionally always being able to have the same width between the forks of the sliding fork-shaped system;
the forks are moved via a rack and pinion system, which enables boats to be taken from, or stored to, either side of the tower, once the sliding fork-shaped system has been aligned with, and engaged in, the cradle, with the help of the correctly located sensors—this enables the boat to be handled without knocks or judders, and thereby eliminates risk of damage to the boat;
the boats are stored longitudinally and perpendicularly to the portside quay, which when coupled with the fact that the handling device only requires a minimum length of 7 metres for complete operational movement, allows for up to between 60% and 200% more boats to be stored in any given surface area when compared to a classical dry dock system, even those which are semi-automatic;
the number of stories of storage is relatively large, for example 6 or 7 stories are possible;
removing boats from storage and introducing them to the water, and the reverse operation of removing them from the water and depositing them for storage, can be carried out without having to load and unload more than once, and without the boat being manhandled, through the use of the cradle.

The accompanying figures, provided for purposes of non-limiting illustration of the invention, are included to better facilitate comprehension of the features and advantages of the device according to the invention:

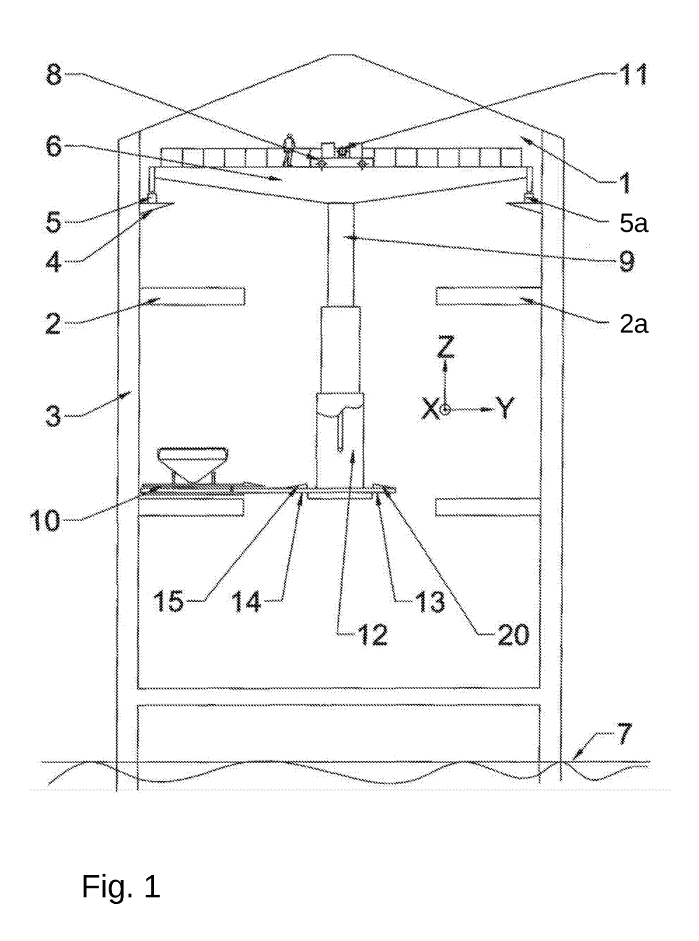

FIG. 1 is a cross-sectional representation of a storage opening within a housing;

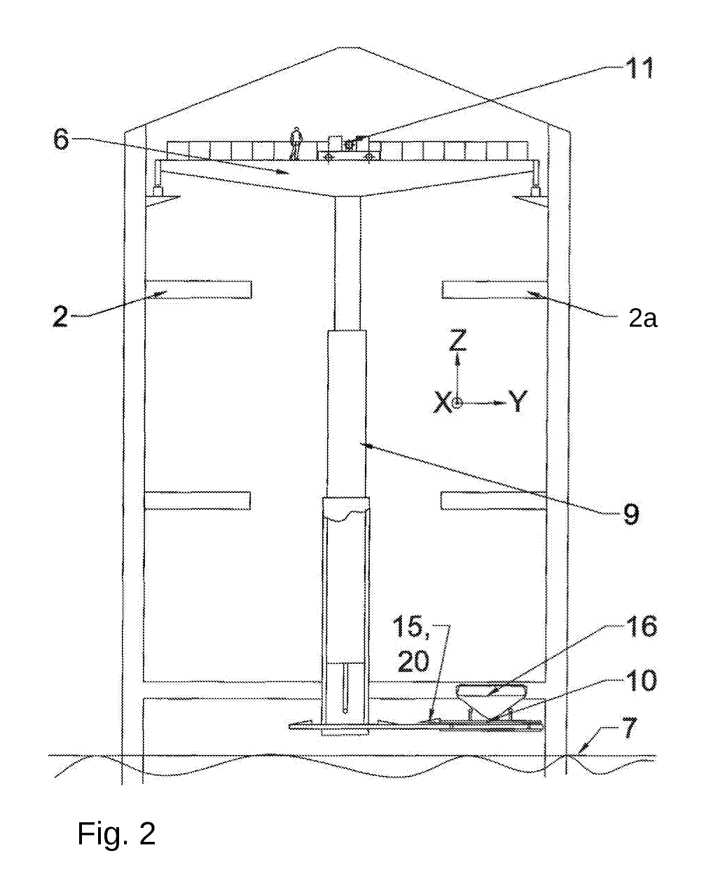

FIG. 2 is a representation of a telescopic tower and sliding fork-shaped removing a boat from the water;

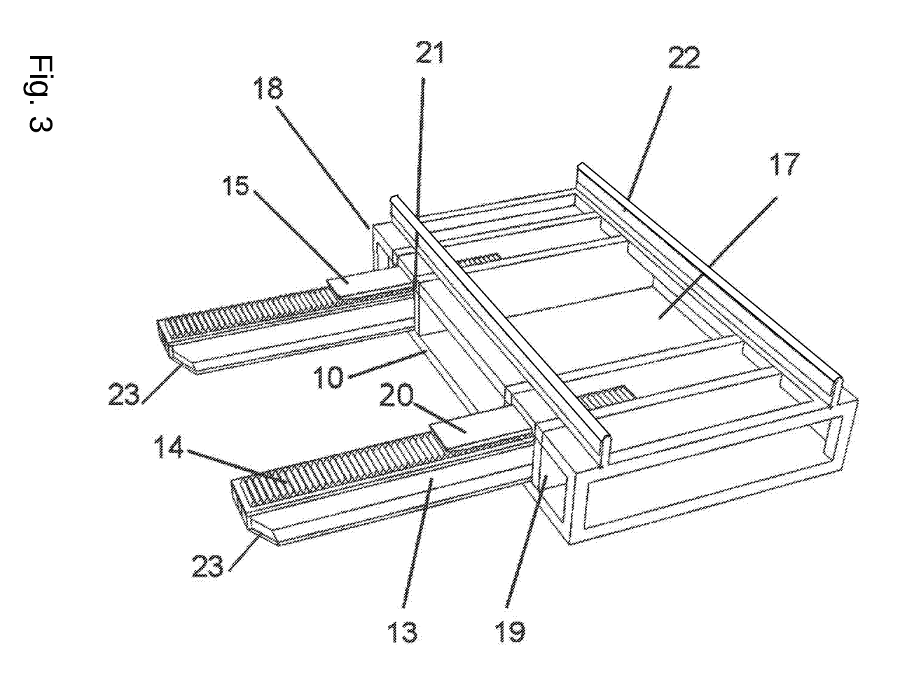

FIG. 3 represents a cradle and the positions of the location sensors on the forks of the sliding fork-shaped system, as well as the location of the rack and pinion means;

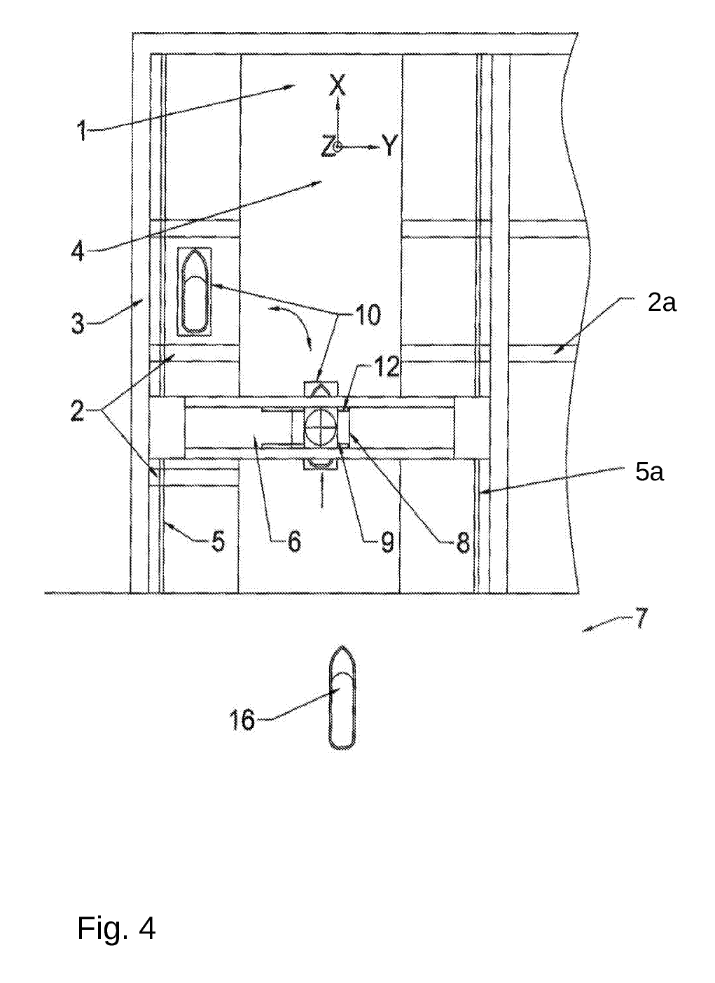

FIG. 4 represents a cross-sectional view of a boat hangar seen from above;

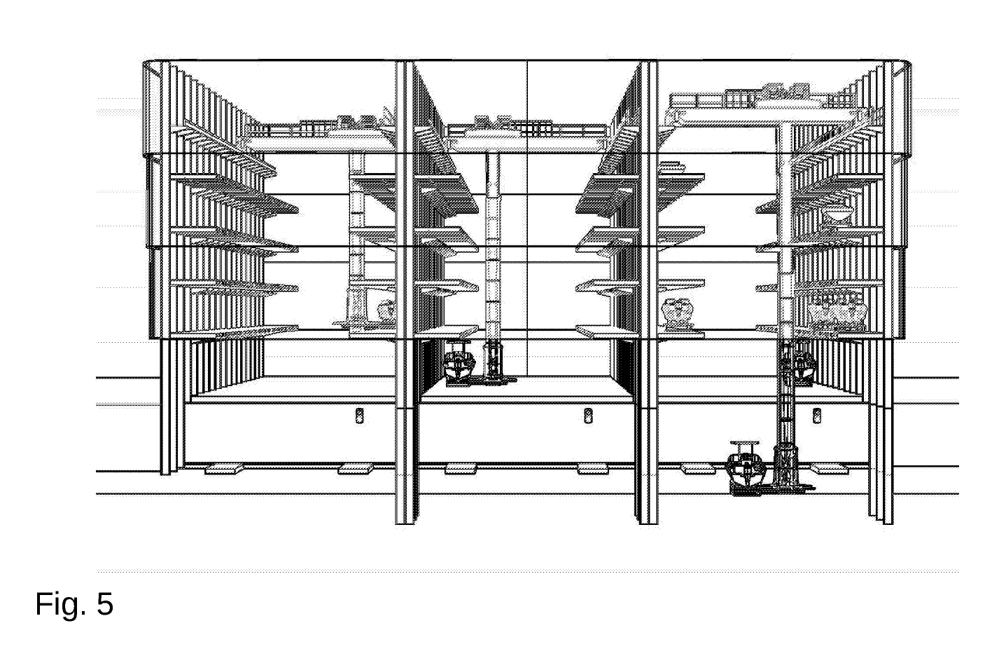

FIG. 5 is a schematic representation of a boat storage system, or vertical dry dock system and device according to the present invention, where several storage halls are illustrated, side-by-side, each one equipped with a manipulation system according to the present invention;

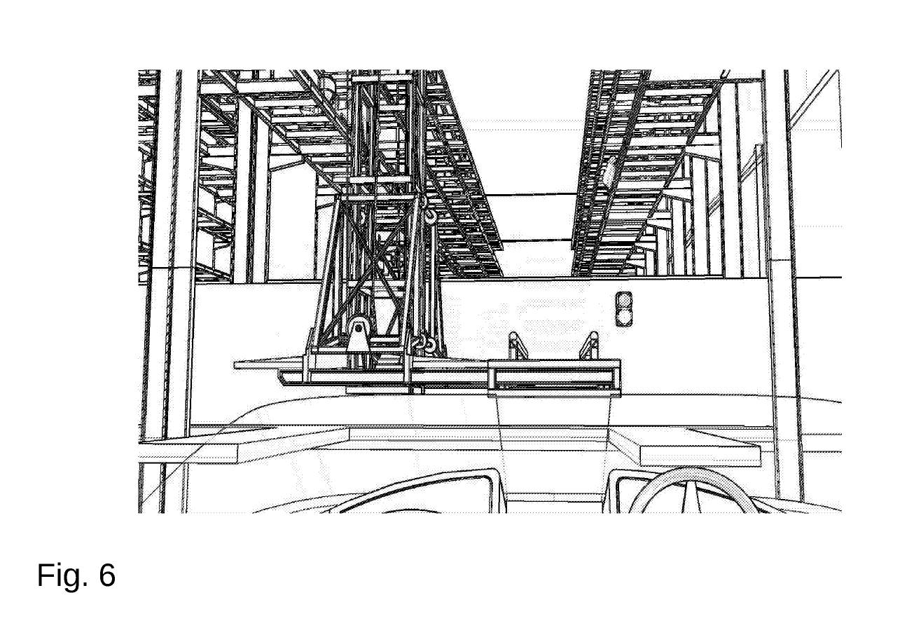

FIG. 6 is a schematic representation of part of the telescopic tower, and the sliding forklift system being either brought into position relative to, or moved away from, a boat located on the water;

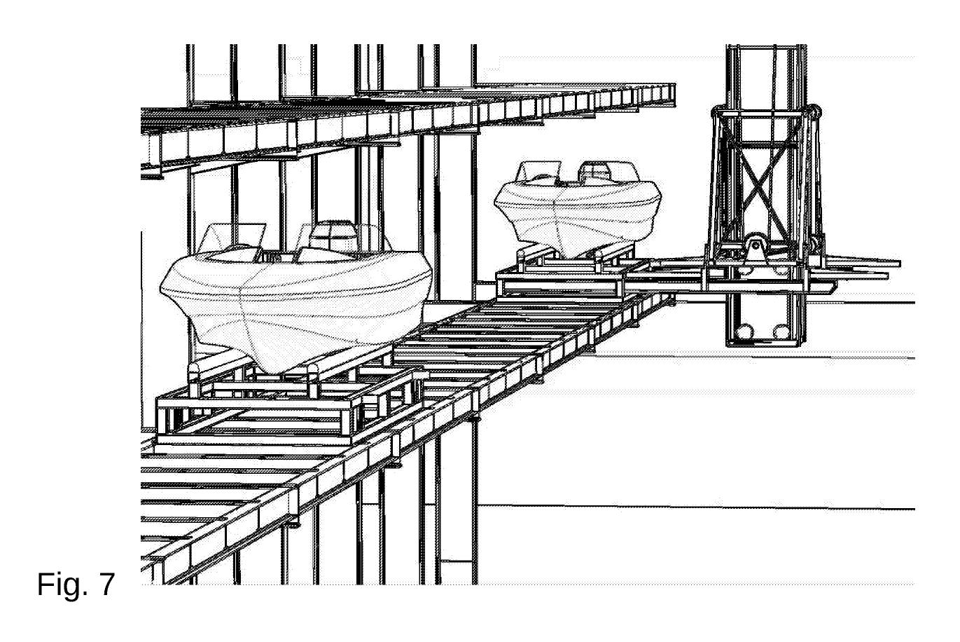

FIG. 7 is a schematic partial representation of the vertical dry dock system according to the invention, showing in particular part of the telescopic tower, forklift system, and boat support cradle when depositing or removing a cradle with boat onto, or from, a berthing space.

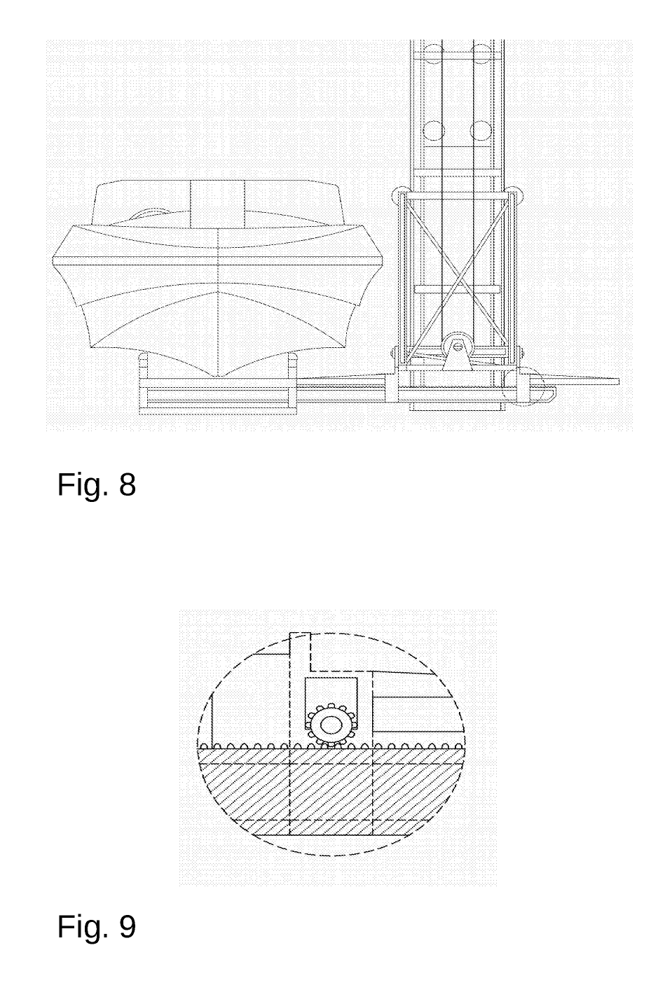

FIG. 8 is a schematic representation of the view side-on to the sliding forklift system, cradle and boat located thereon;

FIG. 9 is an enlarged view of the schematic representation in FIG. 8, illustrating the detail of the rack and pinion means in the sliding forklift system;

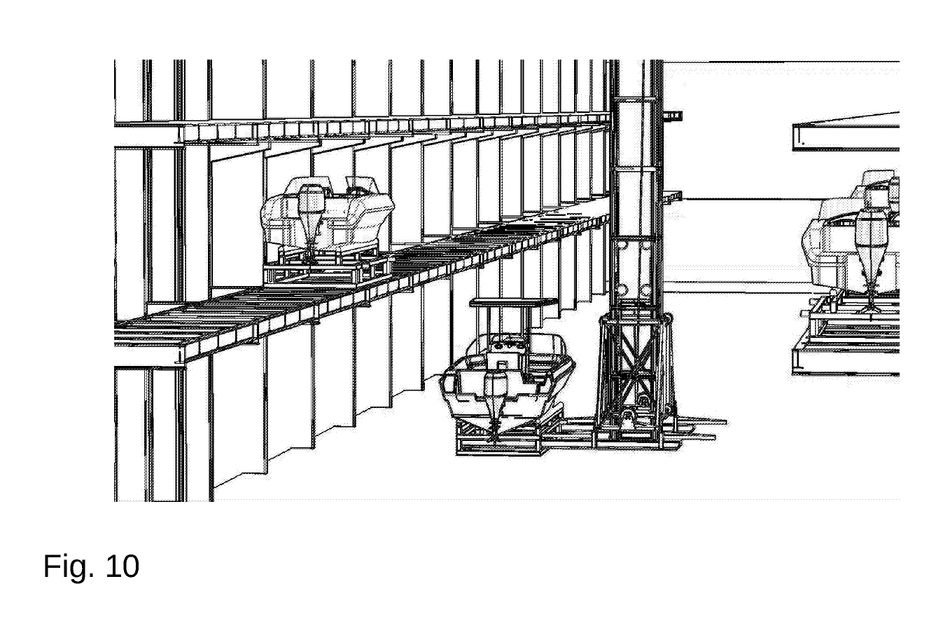

FIG. 10 is a schematic representation of a boat being removed via its cradle, the sliding forklift system and telescopic tower (in part) from a ground floor berthing space within the boat storage system according to the present invention.

Turning now to the Figures, FIG. 1 is a cross-sectional schematic representation of a vertical dry dock (1) including storage spaces which form berths (2, 2a). Vertical uprights (3), having berth supports (2, 2a), support rails (5, 5a), on either side of a central opening or corridor (4), which form a roll path for a rolling bridge (6) that can be moved along the whole length of the corridor (4), as well as above the port water area (7).

A movable chariot structure (8) is movable along parallel beams forming the rolling bridge (6). The movable structure (8) carries a telescopic sliding tower (9) that enables boat support cradles (10) to be lowered or raised and moved vertically along a Z axis, and horizontally along the X and Y axes, whereby the cradles are carried via a horizontally sliding, and vertically height-adjustable, forklift system (12) which itself engages with the telescopic lifting tower (9), the latter being raised or lowered, for example, via pulleys (11) or hydraulic pistons, or other suitable mechanical means. The forks (13) both carry, engage and cooperate with, the rigid cradles (10). The forks (13) can be moved horizontally either side of an axis defined by the vertical axis of the telescopic tower (9), both via rack and pinion systems (14) that are provided on the sliding forklift system (12), and via movement of the sliding telescopic tower (9) and chariot (8) along the rolling bridge (6). Positioning sensors (15, 20), located above the rack and pinion systems (14), cooperate with corresponding sensors located on the cradles (10), thereby causing the motors of the rack and pinion systems to stop and and thus arrest any relative movement of the forks in each possible direction of movement.

In FIG. 2, the rolling bridge (6) which carries the telescopic tower (9) is represented. The tower (9) enables boats (16) to be raised from, or lowered onto, the water (7). The cradles (10), equipped with positioning sensors (15, 20), are lifted by a combination of movements along the X, Y and Z axes, of the sliding forklift system, telescopic tower, and rolling bridge, in order to deposit the boats precisely onto their berths (2, 2bis).

In FIG. 3, a boat support cradle (10) has been illustrated. The cradle has the following components :
a lower part (17) with a substantially rectangular base is subdivided into two further identical and opposite framework sections (18) forming cavities (21) and cross-support struts (19). The cavities (21) and cross-support struts (19) enable the forks to be introduced and moved within the cradle base. The cradle base is designed so that the forks (13) bearing the rack and pinion systems (14), which are located on metal profiles (23) on the forks, can be slid into the cavities (21). The lower part (17) of the cradle also contains positioning sensors (15, 20) configured to determine the limits of forward and backward movement of the forks which cooperate with corresponding sensors on the forklift system;
an upper part of the cradle is configured in shape and form to conform to the shape of the boats it is to receive and carry, but is also provided with reinforcing struts (22) made for example, of softwood and covered, in a suitable material, for example rubber, or an impact resistant or impact absorbing plastic, viscoelastic or elastomeric material, in order not to damage the boat hull.

FIG. 4 represents 4 a cross-sectional view from above of a vertical dry dock (1) and illustrating:
the storage spaces and berths (2, 2a) and vertical uprights (3);
the rolling bridge (6), supported by rails (5, 5a) either side of the corridor or opening (4);
a structure (8) carrying the sliding telescopic tower (9), said structure being movable along the rolling bridge (6);
boats (16) on the water (7) and boats being raised via the telescopic tower (9), and sliding fork system;
cradles (10) located in their respective berths (2,2a);
the tower (9) being raised or lowered to deposit the boat support cradle (10) at the required height for the supports (3) in the uprights;
boats being moved via the sliding forklift system (12) to their respective berths and depositing the cradle (10) on the berth (2, 2a).

According to another preferred embodiment, as represented in FIG. 5, it is possible to organize several adjoining storage halls or buildings. As each hall can store on average up to 125 boats, depending on the boat size, five similarly arranged halls would provide storage space for up to 625 boats. The boats are stored on shelves formed by the support struts and corresponding uprights. Each boat is stored parallel to the length of the hall, nose-to-tail on the racks, with an average spacing of approximately 500 millimeters between the nose of one boat and the corresponding tail of the next boat in front. The precision of the system is such that this can be achieved without damaging the boats in any way. As the handling system according to the present invention are fairly rigid, the boats do not sway or twist, such as one might find with a cable suspended cradle or grabs attached to a cable. The various handling systems can all be operated independently of one another, and fully automatically as will be described hereinafter. This means that the storage systems according to the present invention can deposit or remove any given boat from any given berth in a programmed, orderly manner, thereby saving both operating and personnel costs. Each storage building or hall can be approximately 100 meters long and approximately 15 meters wide. The central corridor is then generally about 8.8 meters wide. The boats are stored, as mentioned above, parallel to the length of the building on berthing shelves that are approximately 3 meters in depth. The building can have up to about 5 levels of storage, including the ground floor, or more if required.

Each new boat to be stored is registered with a management system, for example, when the boat owner subscribes to a storage service—the management system can be computer controlled, for example, with data residing on one or more servers or electronic storage systems, and the data being used to coordinate the movement and handling manoeuvres of the boats;

When a subscription for storage is taken out, for example, a cradle is reserved for the boat which corresponds to the size of the boat to be handled—in order to do this the boats specifications are entered into the system, and the boat is measured and weighed, for example using the sliding forklift system and sensors;

The cradle comprises two main parts, a lower part, which is common to all of the cradles, with a framework and reinforcing struts, for example, made of tubular steel, and an upper part, the size and dimensions of which are adapted to the size of the boat. Although there is a substantial number of boat sizes, the applicant has determined that most cases can be met with just three different types of upper part for the cradle, although naturally, more than three types could be designed to cater for all manner of shapes and sizes of boat, especially for larger ones. The upper part of the cradle that comes directly into contact with the hull of the boat is preferably made from wood, for example softwood, optionally with a further coating or curshioning, such as rubber, or a suitable elastomeric or plastics material, capable of absorbing shocks and preventing or reducing direct contact damage to the boathulls;

The lower part of the cradle also comprises orifices adapted to receive and engage with the forks from the sliding forklift system. These orifices are identical for each type of cradle with regard to their spacing, distribution, dimensions, etc, The lower part of the cradle is furthermore provided with positioning sensors, that cooperate with corresponding sensors on the sliding forklift system.

In an exemplary embodiment, the forks of the sliding forklift system have a depth of approximately 200 millimeters, which in turn means that the height of the orifices in the lower part of the cradle would be at least about 250 millimeters.

The system according to the invention makes it impossible for a boat to be manipulated directly by the sliding forks, as it is programmed to only pick up a boat that is already on a cradle. This avoids any risk of damage to the boathulls through imprecise or incorrect movement of the sliding fork system and also guarantees the physical integrity of the boats both moving into, and out of, storage.

When the system is in operation, and the telescopic tower inside the building or hall, the latter at rest is always in a raised, uppermost, or vertically withdrawn, position. This also allows for movement of personnel within the central corridor or passage, or maintenance or service vehicles. When a boat requires handling, the telescopic tower is activated to initially extend downwards from its uppermost position, and then move up and down according to the desired positioning of the boat on its cradle, whether it be to deposit the boat on a berth, or to place it on the water. The telescopic tower can be moved up and down via a winch system, and appropriately equipped braking and security systems that can be controlled remotely.

The horizontal sliding forklift system comprises a frame that is adapted to be vertically movable up and down a relatively short distance of the telescopic tower. This allows for fine tuning of the vertical positioning of the sliding forklift system. The vertically movable frame can for example, be moved by a winch system, itself also equipped with suitable braking and security means, and means allowing it to be controlled remotely. The vertically movable frame can comprise, for example, drive wheels having a circumferential slot that engages by friction with a corresponding projecting rail on the telescopic tower, or any other equivalent well known means of enabling such movement. The sliding forks are moved by motors housed within the frame that turn a pinion, the teeth of which engage with a rack located on the upper surface of the forks and extending at least partially along the length thereof. The racks are located either side of a vertical axis that is defined by the vertical axis of the telescopic tower. As each fork is made of a continuous strip of material, for example, steel, this enables the forks to slide horizontally in both a leftward and rightward direction on command in order to be able to engage with the cradle on either side of the central passage or corridor of the hall. Preferably, the drive motors for the rack and pinion systems are waterproofed, in order to maintain functionality and protect the mechanisms from corrosion when the sliding forklift system is immersed in the water.

The system further preferably comprises suitable electrical power means for powering up the various components, motors, and command and control equipment.

As can be seen from the figures, the telescopic tower comprises a guide mast and a a telescopic frame that moves vertically relative to the guide mast. The guide mast is generally is welded structure made of steel. The guide mast can be welded to the movable chariot or affixed by another suitable means. Guide wheels are provided on the guide mast in order to facilitate guiding of the telescopic framework located around the guide mast. The telescopic framework is mainly comprised of a trellis or latticework of interconnected pipes, bars or struts to create a pylon. It is also provided with guide rails for the sliding forklift system and for the guide mast, and can have a pulley or winch system to assist in lifting the structure.

As mentioned above, the horizontal sliding forklift system is comprised of a framework, which can also be a latticework or trellis of interconnected pipes, struts or bars, the dimensions of the framework being such that it is located around, and can move vertically up and down, the telescopic framework of the telescopic tower, which in turn is provided with guide wheels which engage with the telescopic mast framework. The framework carries the sliding forks, but also positioning sensors located above the forks, and additionally measurement arms laterally spaced from the forks on either side of the vertical axis defined by the tower. These measurement arms can comprise laser sensors used to carry out positioning and other measurements, for example, measurements related to the size, shape and weight of the boat. The laser sensors are preferably located affixed to the underside of the measurement arms, and interact with corresponding positioning sensors located on the upper surface of the the cradle in order to assist in positioning the forks within the orifices provided for that purpose in the cradle. Sensors are preferably also mounted laterally within each measurement arm, and also serve to assist in vertical positioning of the forks for engagement with the orifices of the cradle.

In addition to the above sensor systems, the handling system according to the invention is further preferably provided with a water level sensor, to detect and determine the level of the water into which, or from which the boat is to be placed or retrieved. A central processing unit, for example a computer server, or equivalent functional system, can be provided to manage the data, exchanges with the components, and sensors, and command and control the system. This can advantageously be located outside of the storage hall, in which case the hall can be equipped with surveillance means, such as cameras, or other location sensors, connected to the command and control system, enabling remote control and verification of the operational functioning of the system.

The management system used to command and control the handling system and operate the machinery can be based on a client server software program for example, with integrated logistics management. An operator will have at his disposal a series of programs enabling him to interact with the systems mechanical components. Among others, the system can provide the following:
system diagnostics and messages;
statistics and trace analysis, and maintenance schedules;
user management functions for operators, administrators, service personnel, etc
visual representations of the storage spaces and occupied or reserved spaces in the hall;
space allocation and management;
database management to manage boat data and owner details;
logistics capabilities for primary registration of boats;
means for managing and displaying the order of boat movements and handling, relayed to a display on site, for example, within a clubhouse, for boat owner information;
logging systems for transaction surveillance and auditing.

The functioning of the system can be described generally as follows:

A boat arrives for primary registration with the system;

The boat owner notifies reception of the arrival of his boat and provides relevant required details;

The boat management system assigns a cradle to the boat according to the boats size, weight and other measurement data, as well as a berth in the storage hall. The boat owner receives a badge which uniquely identifies both him, the boat and the corresponding storage location. This data is kept in the management system for further reference and use;

The storage halls can optionally be provided with a reserved space for the reception of boats via land transport, in which service personnel can work safely, and which is separated from the handling system by an openable closure or separation system. This allows the automated handling system to continue operation without endangering the service personnel;

The boat, whether arriving by land transport or via water, is identified by the system, for example, via the owner's badge or an optical surveillance system;

If a boat has arrived via water, as would usually be the case, the boat approaches a small jetty or pontoon and is moored temporarily by the skipper. He uses his badge to activate the system, either via a remote detection system or a service stand near the jetty;

The boat then enters a queue for handling the processing request;

A member of the service personnel of the storage facility can see which boats have arrived or are departing and which is next in line to be handled;

Optional security systems can be provided to ensure that boats are not removed or manipulated by unauthorised personnel, for example, movement sensors can be provided quayside and at the berths in order to detect any unauthorised movement;

Within the hall the system is activated to being handling processing;

The rolling bridge is then moved automatically, the management and storage system executing the instructions and communicating with the equipment to move the rolling bridge into position, and commanding the sliding forks to move to the corresponding assigned berth, engage with the cradle, and lift it up;

An optional safety feature can be provided wherein the support struts of the storage berths have an additional sensor that communicates with the system and the forks own sensors on the measurement arm to recalibrate the position of the forks as required;

Only once positioning has been deemed to be complete, are the fork motors commanded to move the forks forward and into the orifices in the cradle;

The cradle is then lifted by upward movement of the sliding fork system;

The forks are then moved backwards, drawing the cradle away from the berth;

The telescopic tower carrying the cradle via the sliding fork system is then moved towards the exterior of the building and the waterside;

The cradle is lowered into the water to a depth below the lowest point of the boat hull, the water level being detected by a sensor that communicates with the management system;

The cradle is positioned approximately 1.5 meters below the lowest point of the hull, and then the sliding fork motors actuated to bring the cradle underneath the boat and positioned at the correct spot for subsequent lifting—as the parameters of the boat are known to the system beforehand, this operation occurs automatically;

Additionally, the boat can optionally have a marking on its hull corresponding to its longitudinal center of gravity, defined by and known to the management system, where laser positioning guarantees correct alignment of the boat with the cradle;

The cradle is then lifted to meet the boat hull;

Optional visual inspection by an operator or a surveillance system can provide additional safety measures for correct handling and positioning of the boat;

The lifting system can also optionally comprise weight measuring means, for example dynamometric measuring means, enabling the system to determine if an anomalous weight is present in the boat compared to the declared weight, and which would be likely to shift the know center of gravity and endanger the handling operation;

The rolling bridge then moves the cradle, boat and sliding forklift system back into the storage hall, positioning the sliding forks slightly above the assigned berth;

The fork motors are engaged to advance the cradle at the correct position over the berth, and then the cradle is lowered onto the berth space;

The fork motors are then re-engaged to withdraw the forks from the cradle and the operation is complete.

A boat can be placed into the water, ready for its owner, in a reverse manner to the above. When the owner arrives at the storage facility, he uses his badge to activate the system, or alternatively books this in advance via e-mail or another acceptable remote form of communication and validation. The owner knows how long it will take for the boat to be made ready from the display system, which shows the list of boats being handled and their priority scheduling.

1. Device for manipulating boats, vehicles or other loads requiring storage in spaces located either side of parallel openings in storage buildings formed from superimposed storage spaces, designated storage berths, positioned longitudinally, to receive cradles, the device being carried by a rolling bridge that is moved along rails which are an integral part of the lateral framework of said openings, characterised in that the rolling bridge carries a telescopic tower and a sliding forklift system for lifting boats out of the water, the cradles being carried by the sliding forklift system having a variable length enabling the cradles to be deposited on the berths.

2. Device according to claim 1, characterised in that the telescopic tower is movable along the rolling bridge and carried by a movable chariot perpendicularly to the X and Y axes of the rolling bridge.

3. Device according to claim 1, characterised in that the cradles are adapted to the shape of the load with regard to the cradle's upper part and to the prehensile system for the cradle's lower part.

4. Device according to claim 1, characterized in that the cradles are carried by the tower structure and by profiles bearing rack and pinion systems, which are adjustable in length via engagement in openings provided within the free width of the cradles and enabling a boat to be handled without the handling tool coming into contact with the hull of the boat.

5. Device according to claim 1, characterized in that boats are stored in dedicated spaces on berths via scanning to memorize the shape and features of the boat load.

6. Device according to claim 4, characterized in that the cradles and forks are brought into contact with each other automatically via the use of positioning detectors or sensors.

7. Device according to claim 1 wherein the sliding forklift system comprises means for moving forks of the forklift system horizontally with respect to vertical movement of the telescopic tower.

8. Device according to claim 1 wherein the sliding forklift system comprises a rack and pinion system enabling horizontal movement of the forks to engage with, and withdraw from, said cradles.

9. Method for the management and storage of boats in a vertical dry storage system, comprising:
registration of a boat with an automated boat storage and management system;
recognition of a registered boat;
handling of said registered boat by said automated boat storage and management system to effect the storing, or making available, of said boat.

10. Automated boat management system for the management and storage of boats in a vertical dry storage system, comprising:
an automated boat manipulation and storage device;
command and control means for operating the automated boat manipulation and storage device;
boat identification means for uniquely identifying a boat in the automated boat management system and causing the command and control means to operate the automated boat manipulation and storage device.
